(19) United States
(12) Patent Application Publication
(10) Pub. No.: US 2018/0134010 A1
(43) Pub. Date: May 17, 2018

(54) COMPRESSIBLE, MULTILAYER ARTICLES AND METHOD OF MAKING THEREOF

(71) Applicant: 3M INNOVATIVE PROPERTIES COMPANY, St. Paul, MN (US)

(72) Inventors: Margot A. BRANIGAN, Roseville, MN (US); Michael Benton FREE, Stillwater, MN (US); David T. AMOS, St. Paul, MN (US); Robert F. KAMRATH, Mahtomedi, MN (US); Stephen A. JOHNSON, Woodbury, MN (US); John D. LE, Woodbury, MN (US)

(21) Appl. No.: 15/567,253

(22) PCT Filed: Apr. 13, 2016
(86) PCT No.: PCT/US2016/027264

§ 371 Date: Oct. 17, 2017

Related U.S. Application Data
(60) Provisional application No. 62/149,088, filed on Apr. 17, 2015.

(51) Int. Cl. B32B 27/06; B32B 5/18; B32B 27/36; B32B 37/18; G01L 1/14

(52) U.S. Cl. CPC B32B 27/065; B32B 5/18; B32B 27/36; B32B 37/182; G06F 3/044; B32B 2266/0292; B32B 2457/16; B32B 2255/10; G01L 1/146

(57) ABSTRACT

The present disclosure relates to compressible, multilayer articles useful in force sensing capacitors. The compressible multilayer articles include a silicone polymer layer having a first major surface and a second major surface and a first primer layer having a first major surface and a second major surface, wherein the thickness of the first primer layer is from about 100 nanometers to about 100 microns and at least a portion of the first major surface of the first primer layer is adhered to and in contact with the first major surface of the silicone polymer. The multilayer articles may include at least one of a first electrode and second primer layer. Methods of making the compressible, multilayer articles are also disclosed.

### TECHNICAL FIELD

The present disclosure relates to compressible multilayer articles useful in force sensing capacitors.

### BACKGROUND

Force-sensing capacitor elements have been contemplated or applied for many years in touch displays, keyboards, touch pads, and other electronic devices. The recent renaissance of the touch user interface (paradigm shift from resistive to projected capacitive) has catalyzed a renewed interest among electronic device makers to consider force-sensing. The main challenges associated with the integration of force-sensing with the display of an electronic device, for example, include linearity of response, speed of response and speed of recovery, preservation of device mechanical robustness, preservation of device hermiticity where desired, thinness of construction, sensitivity, determination of position or positions of force application, and noise rejection. The compressible multilayer articles of the present disclosure, when used to fabricate force sensing capacitor elements, have advantages in the areas, for example, of response speed and recovery speed, linearity of response, thinness, and determination of touch position.

### SUMMARY

The present disclosure relates to compressible multilayer articles useful in, for example, force-sensing capacitor elements. Force sensing capacitor elements have wide utility in a variety of applications including electronic devices that include, for example, touch screen displays or other touch sensors. The compressible multilayer articles can be integrated within a force-sensing capacitor element of a display or electronic device, for example, to detect and measure the magnitude and/or direction of force or pressure applied to the display or electronic device. The force-sensing capacitor elements, which include the compressible multilayer articles of the present disclosure, can be integrated, for example, at the periphery of or beneath a display, to sense or measure force applied to the display. Alternatively, the force-sensing capacitor elements can be integrated within a touch pad, keyboard, or digitizer (e.g., stylus input device), for example.

In one aspect, the present disclosure provides a compressible multilayer article including:

a silicone polymer layer having a first major surface and a second major surface; and

a first primer layer having a first major surface and a second major surface, wherein the thickness of the first primer layer is from about 100 nanometers to about 100 microns and at least a portion of the first major surface of the first primer layer is adhered to and in contact with the first major surface of the silicone polymer. The compressible, multi-layer article may further include a second primer layer having a first major surface and a second major surface, wherein the thickness of the second primer layer is from about 100 nanometers to about 100 microns and at least a portion of the first major surface of the second primer layer is adhered to and in contact with the second major surface of the silicone polymer.

In another aspect, the present disclosure provides a compressible, multilayer article including:

a silicone polymer layer having a first major surface and a second major surface;

a first primer layer having a first major surface and a second major surface, wherein the thickness of the first primer layer is from about 100 nanometers to about 100 microns and the first major surface of the first primer layer is adhered to and in contact with the first major surface of the silicone polymer; and

a first electrode having a first major surface and a second major surface, wherein the first major surface of the first electrode is adhered to and in contact with the second major surface of the first primer layer. The compressible, multilayer article may further include a second primer layer having a first major surface and a second major surface, wherein the thickness of the second primer layer is from about 100 nanometers to about 100 microns and the first major surface of the second primer layer is adhered to and in contact with the second major surface of the silicone polymer; and a second electrode having a first major surface and a second major surface, wherein the first major surface of the second electrode is adhered to and in contact with the second major surface of the second primer layer.

In another aspect, the present disclosure provides a method of making a compressible, multilayer article including:

providing a silicone polymer layer having a first major surface and a second major surface;

applying a first primer layer to the first major surface of the silicone polymer layer, wherein the thickness of the first primer layer is from about 100 nanometers to about 100 microns.

The method of making a compressible, multi-layer article may also include:

applying a second primer layer to the second major surface of the silicone polymer layer, wherein the thickness of the second primer layer is from about 100 nanometers to about 100 microns.

The method of making a compressible, multi-layer article may also include:

providing a first electrode having a first major surface and a second major surface and laminating the first major surface of the first electrode to the exposed surface of the first primer layer.

The method of making a compressible, multi-layer article may also include:

providing a first electrode having a first major surface and a second major surface and a second electrode having a first major surface and a second major surface; laminating the first major surface of the first electrode to the exposed surface of the first primer layer; and laminating the first major surface of the second electrode to the exposed surface of the second primer layer.

In another aspect, the present disclosure provides a method of making a compressible, multilayer article including:

providing a first electrode having a first major surface and a second major surface;

applying a first primer layer to the first major surface of the first electrode, wherein the thickness of the first primer layer is from about 100 nanometers to about 100 microns;

providing a silicone polymer layer having a first major surface and second major surface; and

laminating the first major surface of the silicon polymer layer to the exposed surface of the first primer layer. The method of making a compressible, multi-layer article may further include:

providing a second electrode having a first major surface and a second major surface; applying a second primer layer to the first major surface of the second electrode, wherein the thickness of the second primer layer is from about 100 nanometers to about 100 microns; and laminating the second major surface of the silicone polymer layer to the exposed surface of the second primer layer

### BRIEF DESCRIPTION OF THE DRAWINGS

FIG. 1A is a schematic cross-sectional side view of a portion of an exemplary compressible multilayer article according to one exemplary embodiment of the present disclosure.

FIG. 1B is a schematic cross-sectional side view of a portion of an exemplary compressible multilayer article according to one exemplary embodiment of the present disclosure.

FIG. 1C is a schematic cross-sectional side view of a portion of an exemplary compressible multilayer article according to one exemplary embodiment of the present disclosure.

FIG. 1D is a schematic cross-sectional side view of a portion of an exemplary compressible multilayer article according to one exemplary embodiment of the present disclosure.

FIG. 1E is a schematic cross-sectional side view of a portion of an exemplary compressible multilayer article according to one exemplary embodiment of the present disclosure.

FIG. 2A is a schematic cross-sectional side view of a portion of an exemplary compressible multilayer article according to one exemplary embodiment of the present disclosure.

FIG. 2B is a schematic cross-sectional side view of a portion of an exemplary compressible multilayer article according to one exemplary embodiment of the present disclosure.

FIG. 2C is a schematic cross-sectional side view of a portion of an exemplary compressible multilayer article according to one exemplary embodiment of the present disclosure.

FIG. 2D is a schematic cross-sectional side view of a portion of an exemplary compressible multilayer article according to one exemplary embodiment of the present disclosure.

FIG. 2E is a schematic cross-sectional side view of a portion of an exemplary compressible multilayer article according to one exemplary embodiment of the present disclosure.

Repeated use of reference characters in the specification and drawings is intended to represent the same or analogous features or elements of the disclosure. The drawings may not be drawn to scale. As used herein, the word “between”, as applied to numerical ranges, includes the endpoints of the ranges, unless otherwise specified. The recitation of numerical ranges by endpoints includes all numbers within that range (e.g. 1 to 5 includes 1, 1.5, 2, 2.75, 3, 3.80, 4, and 5) and any range within that range. Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

It should be understood that numerous other modifications and embodiments can be devised by those skilled in the art, which fall within the scope and spirit of the principles of the disclosure. All scientific and technical terms used herein have meanings commonly used in the art unless otherwise specified. The definitions provided herein are to facilitate understanding of certain terms used frequently herein and are not meant to limit the scope of the present disclosure. As used in this specification and the appended claims, the singular forms “a”, “an”, and “the” encompass embodiments having plural referents, unless the context clearly dictates otherwise. As used in this specification and the appended claims, the term “or” is generally employed in its sense including “and/or” unless the context clearly dictates otherwise.

“Precisely shaped” refers to a topographical structure having a molded shape that is the inverse shape of a corresponding mold cavity, said shape being retained after the topographical feature is removed from the mold.

“Micro-replication” refers to a fabrication technique wherein precisely shaped topographical structures are prepared by casting or molding a polymer (or polymer precursor that is later cured to form a polymer) in a production tool, e.g. a mold, a film with cavities or embossing tool, wherein the production tool has a plurality of micron sized to millimeter sized topographical structures. Upon removing the polymer from the production tool, a series of topographical structures are present in the surface of the polymer. The topographical structures of the polymer surface have the inverse shape as the features of the original production tool. The production tool may be a textured liner or textured release liner that has the inverse pattern of structures as that desired for the final structures.

### DETAILED DESCRIPTION

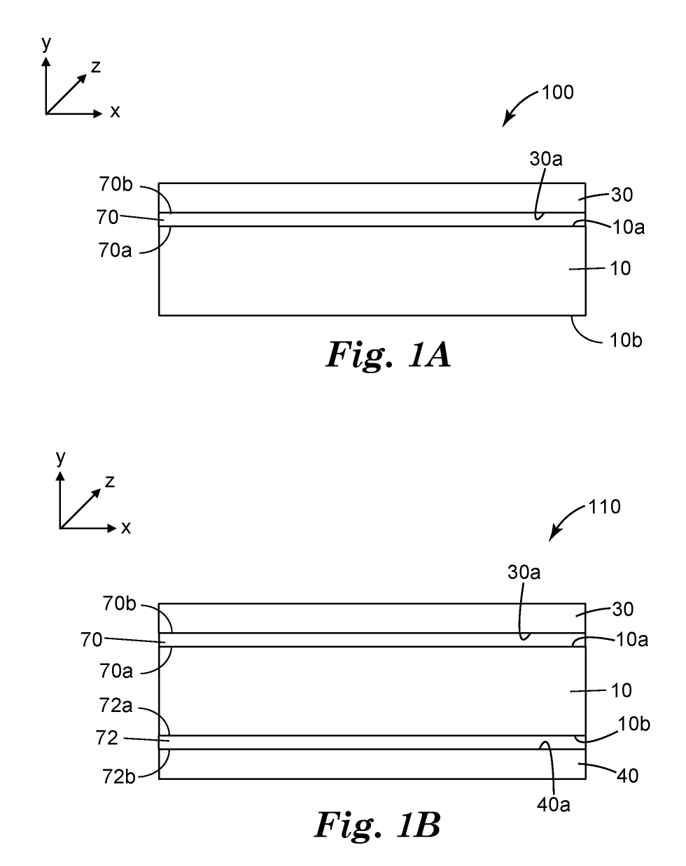

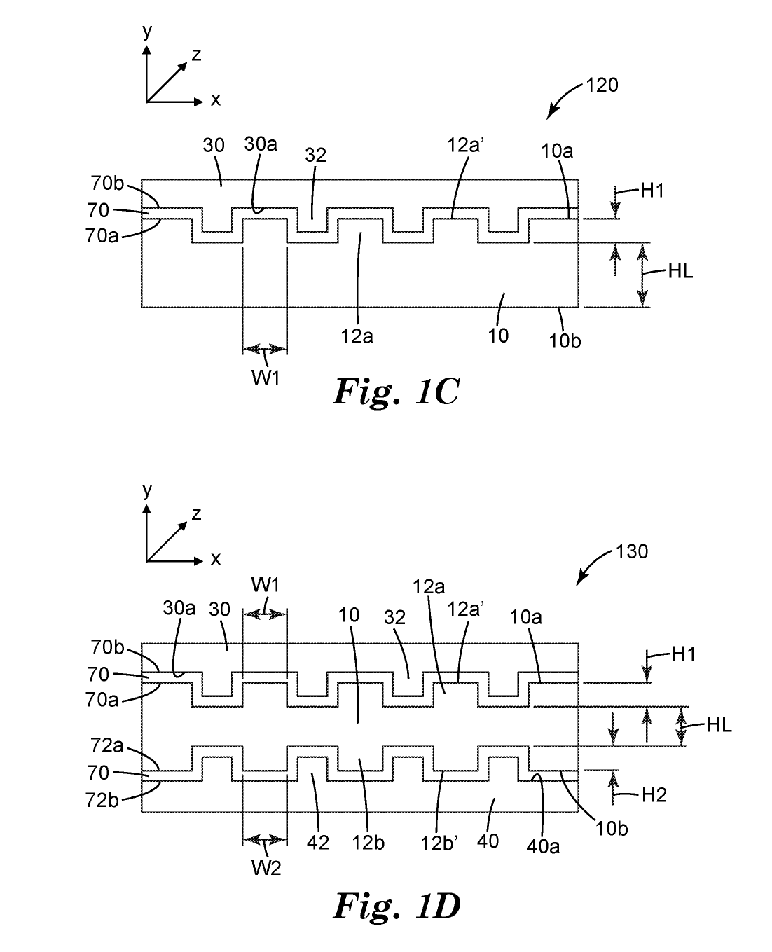

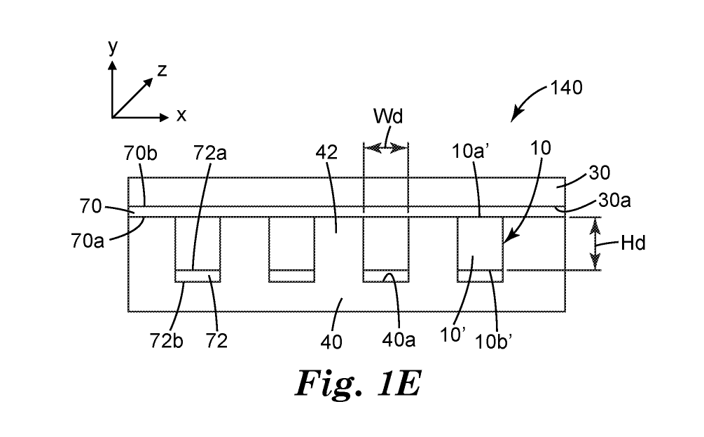

The present disclosure relates to compressible, multilayer articles which include at least one silicone polymer layer (e.g. a cured silicone elastomer), having a first major surface and a second major surface; a first primer, having a first major surface and a second major surface, wherein the thickness of the first primer layer is from about 100 nanometers to about 100 microns and at least a portion of the first major surface of the first primer layer is adhered to and in contact with the first major surface of the silicone polymer. The compressible multilayer articles may further include a second primer layer, having a first major surface and a second major surface, wherein the thickness of the first primer layer is from about 100 nanometers to about 100 microns and at least a portion of the first major surface of the second primer layer is adhered to and in contact with the first major surface of the silicone polymer. The compressible multilayer articles may include an optional first substrate and/or optional second substrate, e.g. release liners. The first substrate has a first major surface in contact with the second major surface of the first primer layer. The second substrate has a first major surface in contact with the second major surface of the second primer layer. One or both of the first major surface and second major surface of the silicone polymer layer may include a plurality of precisely shaped structures. The polymer layer may also include a plurality of precisely shaped discrete structures. The primer layers of compressible, multilayer articles are, generally, very thin, in order to reduce the primer layer's effect on capacitance, when for example, the multilayer article is used in a force sensing capacitor. As the primer layer adds thickness to the dielectric layer and capacitance is, generally, inversely proportional to the dielectric's thickness, it is desired to have thin primer layers. Additionally, the primer layers improve the adhesion to hard-to-bond surfaces, for example, the surfaces of the silicone polymers of the present disclosure. Several specific, but non-limiting, embodiments of the compressible, multilayer articles of the present disclosure are shown in FIGS. 1A through 1E.

Referring now to FIG. 1A, a schematic cross-sectional side view of a portion of an exemplary compressible multilayer article 100 according to one embodiment of the present disclosure, compressible multilayer article 100 includes silicone polymer layer 10, having a first major surface 10a and a second major surface 10b, a first primer layer 70, having a first major surface 70a and a second major surface 70b. First major surface 70a of first primer layer 70 is in contact with and adhered to first major surface 10a of polymer layer 10. FIG. 1A shows optional first substrate 30 with its first major surface 30a in contact with second major surface 70b of second primer layer 70.

FIG. 1B is a schematic cross-sectional side view of a portion of an exemplary compressible multilayer article 110 according to one embodiment of the present disclosure, compressible multilayer article 110 includes a silicone polymer layer 10, having a first major surface 10a and a second major surface 10b, a first primer layer 70, having a first major surface 70a and a second major surface 70b. First major surface 70a of first primer layer 70 is in contact with and adhered to first major surface 10a of silicone polymer layer 10. FIG. 1B shows an optional first substrate 30 having a first major surface 30a in contact with second major surface 70b of primer layer 70. Compressible multilayer article 110 further includes a second primer layer 72, having a first major surface 72a and a second major surface 72b. First major surface 72a of second primer layer 72 is in contact with and adhered to second major surface 10b of silicone polymer layer 10. FIG. 1B also shows an optional second substrate 40 with its first major surface 40a in contact with second major surface 72b of primer layer 72.

FIG. 1C is a schematic cross-sectional side view of a portion of an exemplary compressible multilayer article 120 according to one embodiment of the present disclosure, compressible multilayer article 120 includes silicone polymer layer 10, first primer layer 70 and optional first substrate 30, as previously described with respect to the description of FIG. 1A. First major surface 10a of silicone polymer layer 10 includes a plurality of precisely shaped first structures 12a, each first structure 12a having a distal end 12a′, wherein at least a portion of the distal ends 12a′ of the plurality of precisely shaped first structures 12a are in contact with and adhered to the first major surface 70a of first primer layer 70. In some embodiments, all of the distal ends 12a′ of the plurality of precisely shaped first structures 12a are in contact with and adhered to the first major surface 70a of first primer layer 70. First structures 12a have a height H1 and a width W1, as shown in FIG. 1C. Silicon polymer layer 10 includes a land region, which is the portion of the silicon polymer layer that connects the plurality of first structures together, the land region has a height HL. Optional first substrate 30, as shown in FIG. 1C, includes a first major surface 30a that is a textured surface. The textured first major surface 30a includes a plurality of first substrate structures 32. First substrate structures 32 may be designed and fabricated to have specific shapes and patterns that are the inverse of that desired for precisely shaped first structures 12a of silicone polymer layer 10. The plurality of precisely shaped first structures 12a may then be fabricated using optional first substrate 30 in a micro-replication process, e.g. embossing process, micro-replication process or a molding process to produce silicone polymer layer 10 having a plurality of precisely shaped first structures 12a. In some embodiments, the silicone polymer layer, e.g. a silicone thermoplastic elastomer layer, may conform to the textured surface of the first major of the first substrate. After fabrication, optional first substrate 30 may be removed from compressible multilayer article 120.

FIG. 1D is a schematic cross-sectional side view of a portion of an exemplary compressible multilayer article 130 according to one embodiment of the present disclosure, compressible multilayer article 130 includes polymer layer 10, first primer layer 70, second primer layer 72, optional first substrate 30 and optional second substrate 40, as previously described with respect to the description of FIG. 1B. First major surface 10a of silicone polymer layer 10 includes a plurality of precisely shaped first structures 12a, each first structure 12a having a distal end 12a′, wherein at least a portion of the distal ends 12a′ of the plurality of precisely shaped first structures 12a are in contact with and adhered to the first major surface 70a of first primer layer 70. In some embodiments, all of the distal ends 12a′ of the plurality of precisely shaped first structures 12a are in contact with and adhered to the first major surface 70a of first primer layer 70. First structures 12a have a height H1 and a width W1, as shown in FIG. 1D. Optional first substrate 30, as shown in FIG. 1D, includes a first major surface 30a that is a textured surface. The textured first major surface 30a includes a plurality of first substrate structures 32. First substrate structures 32 may be designed and fabricated to have specific shapes and patterns that are the inverse of that desired for precisely shaped first structures 12a of silicone polymer layer 10. The plurality of precisely shaped first structures 12a may then be fabricated using optional first substrate 30 in an embossing process or a molding process to produce silicone polymer layer 10 having a plurality of precisely shaped first structures 12a. After fabrication, optional first substrate 30 may be removed from compressible multilayer article 130.

As shown in FIG. 1D, second major surface 10b of silicone polymer layer 10 includes a plurality of precisely shaped second structures 12b, each second structure 12b having a distal end 12b′, wherein at least a portion of the distal ends 12b′ of the plurality of precisely shaped second structures 12b are in contact with and adhered to the first major surface 72a of second primer layer 72. In some embodiments, all of the distal ends 12b′ of the plurality of precisely shaped second structures 12b are in contact with and adhered to the first major surface 72a of second primer layer 72. Second structures 12b have a height H2 and a width W2, as shown in FIG. 1D. Silicon polymer layer 10 includes a land region, which is the portion of the silicon polymer layer that connects the plurality of first structures together and the plurality of second structures together, the land region has a height HL. Optional second substrate 40, as shown in FIG. 1D, includes a first major surface 40a that is a textured surface. The textured first major surface 40a includes a plurality of second substrate structures 42. Second substrate structures 42 may be designed and fabricated to have specific shapes and patterns that are the inverse of that desired for precisely shaped second structures 12b of silicone polymer layer 10. The plurality of precisely shaped second structures 12b may then be fabricated using optional first substrate 40 in an embossing process or a molding process to produce silicone polymer layer 10 having a plurality of precisely shaped second structures 12b. In some embodiments, the silicon polymer layer, e.g. a silicone thermoplastic elastomer, conforms to the textured surface of at least one of the first major of the first substrate and first major surface of the second substrate. In some embodiments, the silicon polymer layer, e.g. a silicone thermoplastic elastomer layer, conforms to the textured surface of both the first major of the first substrate and first major surface of the second substrate. After fabrication, optional second substrate 40 may be removed from compressible multilayer article 130.

The size, shape and patterns of first structures 32 and second structures 42, may be the same or may be different. In some embodiments, at least a portion of first structures 32 and second structures 42 align with one another. In some embodiments, all of first structures 32 and second structures 42 align with one another. In some embodiments, none of first structures 32 and second structures 42 align with one another.

FIG. 1E is a schematic cross-sectional side view of a portion of an exemplary compressible multilayer article 140 according to one embodiment of the present disclosure, compressible multilayer article 140 includes polymer layer 10. Polymer layer 10 includes plurality of precisely shaped, discrete structures 10′, each discrete structure 10′ having a first surface 10a′ and opposed second surface 10b′. Discrete structures 10′ have a height, Hd, and a width, Wd, as shown in FIG. 1E. Compressible multilayer article 140 further includes first primer layer 70, having first major surface 70a and second major surface 70b, wherein the first surfaces 10a′ of the plurality of precisely shaped, discrete structures 10′ are adhered to and in contact with the first major surface 70a of first primer layer 70. First tie-layer 70 may be a continuous sheet, as shown in FIG. 1E or may be discrete regions. In some embodiments, compressible multilayer article 140 may include a second primer layer 72, having first major surface 72a and second major surface 72b, wherein the second surfaces 10b′ of the plurality of precisely shaped, discrete structures 10′ are adhered to and in contact with the first major surface 72a of second primer layer 72. Second primer layer 72 may include discrete regions of primer layer 72, corresponding to the discrete structures 10′, as shown in FIG. 1E, or may be a continuous sheet, as shown in FIG. 1A. In some embodiments, first primer layer 70 may be a continuous sheet and second primer layer 72 may be discrete regions, as shown in FIG. 1E. Additionally, a portion of first primer layer 70 and/or second primer layer 72 may be discrete regions and a portion of first primer layer 70 and/or second primer layer 72 may be a continuous sheet that is smaller than the overall area of compressible multilayer article 140.

FIG. 1E also shows an optional first substrate 30, having a first major surface 30a in contact with second major surface 70b of first primer layer 70, and optional second substrate 40, which includes a first major surface 40a in contact with second major surface 72b of second primer layer 72. First major surface 40a of optional second substrate 40 is a textured surface. The textured first major surface 40a includes a plurality of second substrate structures 42. Second substrate structures 42 may be designed and fabricated to have specific shapes and patterns that are the inverse of that desired for precisely shaped, discrete structures 10′ of silicone polymer layer 10. The plurality of precisely shaped, discrete structures 10′ may then be fabricated using optional first substrate 40 in an embossing process or a molding process to produce silicone polymer layer 10 having a plurality of precisely shaped, discrete structures 10′. After fabrication, one or both of optional first substrate 30 and optional second substrate 40 may be removed from compressible multilayer article 140.

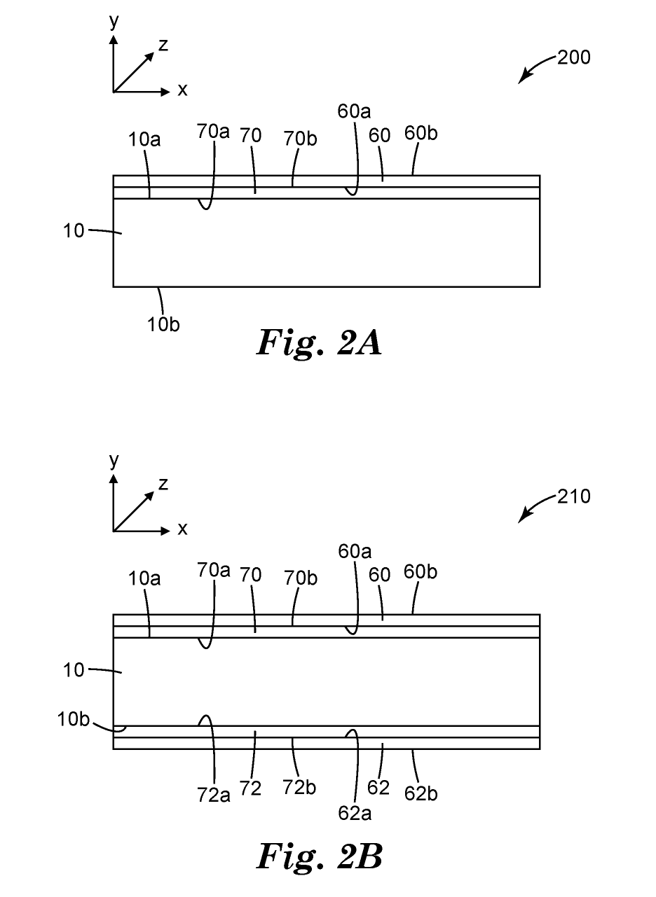

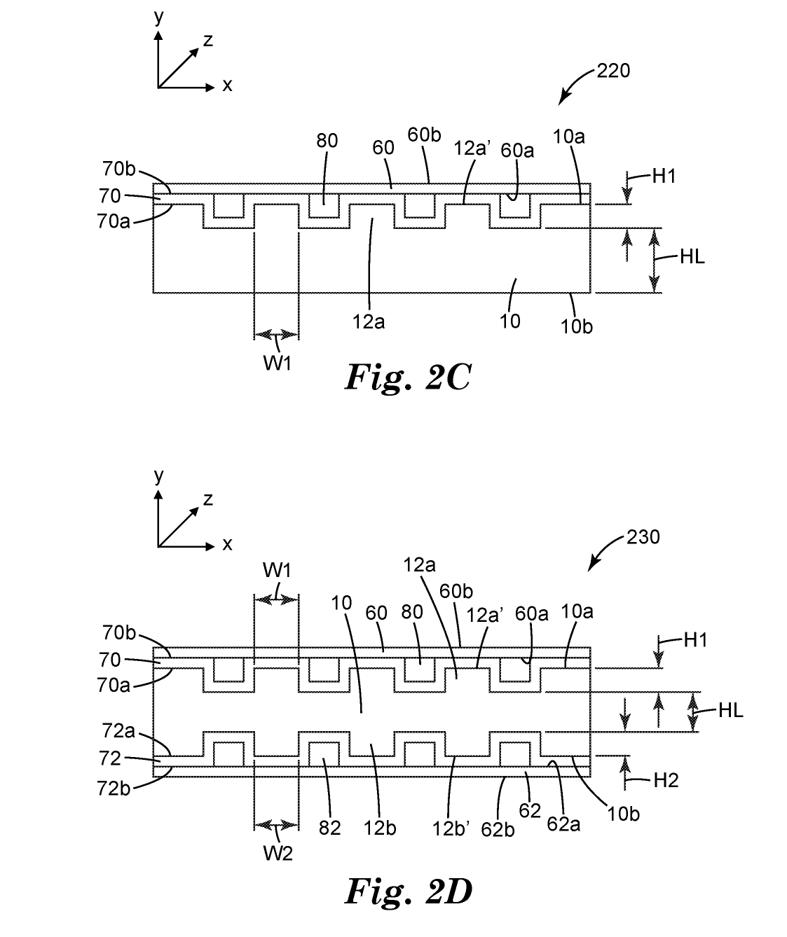

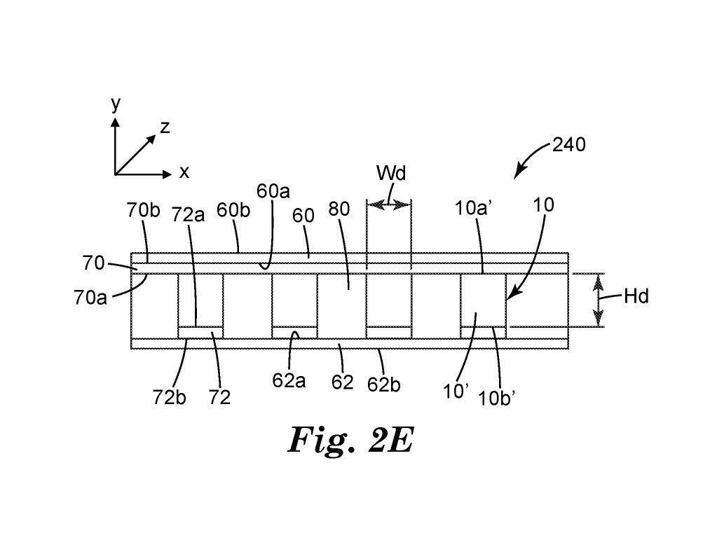

The present disclosure also relates to compressible multilayer articles which include at least one silicone polymer layer (e.g. a silicone thermoplastic elastomer), having a first major surface and a second major surface; a first primer layer having a first major surface and a second major surface, wherein the thickness of the first primer layer is from about 100 nanometers to about 100 microns and the first major surface of the first primer layer is adhered to and in contact with the first major surface of the silicone polymer. The first primer layer may comprise a thermoplastic elastomer (e.g. a silicone polyoxamide) and a coupling agent. The compressible multilayer articles may further include a second primer a second primer layer having a first major surface and a second major surface, wherein the thickness of the second primer layer is from about 100 nanometers to about 100 microns and the first major surface of the second primer layer is adhered to and in contact with the second major surface of the silicone polymer. The second primer layer may comprise a thermoplastic elastomer (e.g. a silicone polyoxamide) and a coupling agent. In some embodiments, the compressible multilayer articles may include a first electrode having a first major surface and a second major surface, wherein the first major surface of the first electrode is adhered to and in contact with the second major surface of the first primer layer. In some embodiments the compressible multilayer articles may further include a second electrode having a first major surface and a second major surface, wherein the first major surface of the second electrode is adhered to and in contact with the second major surface of the second primer layer. One or both of the first major surface and second major surface of the silicone polymer layer may include a plurality of precisely shaped structures. The polymer layer may also include a plurality of precisely shaped, discrete structures. Several specific, but non-limiting, embodiments are shown in FIGS. 2A through 2E.

Referring now to FIG. 2A, a schematic cross-sectional side view of a portion of an exemplary compressible multilayer article 200 according to one embodiment of the present disclosure, compressible multilayer article 200 includes silicone polymer layer 10, having a first major surface 10a and a second major surface 10b, a first primer layer 70, having a first major surface 70a and a second major surface 70b. First major surface 70a of first primer layer 70 is in contact with and adhered to first major surface 10a of polymer layer 10. In one embodiment, the compressible multilayer article 200 may further include a first electrode 60, having a first major surface 60a and a second major surface 60b wherein the first major surface 60a of the first electrode 60 is adhered to and in contact with the second major surface 70b of first primer layer 70.

FIG. 2B is a schematic cross-sectional side view of a portion of an exemplary compressible multilayer article 210 according to one embodiment of the present disclosure, compressible multilayer article 210 includes a silicone polymer layer 10, having a first major surface 10a and a second major surface 10b, a first primer layer 70, having a first major surface 70a and a second major surface 70b. First major surface 70a of first primer layer 70 is in contact with and adhered to first major surface 10a of silicone polymer layer 10. Compressible multilayer article 210 includes a second primer layer 72, having a first major surface 72a and a second major surface 72b. First major surface 72a of second primer layer 72 is in contact with and adhered to second major surface 10b of silicone polymer layer 10. In some embodiments, the compressible multilayer article 210 may further include a first electrode 60 having a first major surface 60a and a second major surface 60b, wherein the first major surface 60a of the first electrode 60 is adhered to and in contact with the second major surface 70b of the first primer layer 70; and a second electrode 62 having a first major surface 62a and a second major surface 62b, wherein the first major surface 62a of the second electrode 60 is adhered to and in contact with second major surface 72b of second primer layer 72.

FIG. 2C is a schematic cross-sectional side view of a portion of an exemplary compressible multilayer article 220 according to one embodiment of the present disclosure, compressible multilayer article 220 includes silicone polymer layer 10, first primer layer 70, and first electrode 60, as previously described with respect to the description of FIG. 2A. First major surface 10a of silicone polymer layer 10 includes a plurality of precisely shaped first structures 12a, each first structure 12a having a distal end 12a′, wherein at least a portion of the distal ends 12a′ of the plurality of precisely shaped first structures 12a are in contact with and adhered to the first major surface 70a of first primer layer 70. In some embodiments, all of the distal ends 12a′ of the plurality of precisely shaped first structures 12a are in contact with and adhered to the first major surface 70a of first primer layer 70. First structures 12a have a height H1 and a width W1, as shown in FIG. 2C. Silicon polymer layer 10 includes a land region, which is the portion of the silicon polymer layer that connects the plurality of first structures together, the land region has a height HL. Compressible multilayer article 220 also includes void regions 80. Void regions 80 are the space or volume between precisely shaped, first structures 12a. The void region may contain a gas, e.g. air, nitrogen and the like. The void regions lower the amount of force required to compress the compressible multilayer article in the y-direction, by replacing portions of silicon polymer layer 10 with a material, i.e. a gas, which has a lower compressive modulus than the silicon polymer layer itself. In some embodiments, the void regions 80 may be interconnected to each other and/or may have fluid communication with the atmosphere surrounding the compressible multilayer article. A compressible multilayer article with void regions having fluid communication with the atmosphere surrounding the compressible multilayer article allows the gas in the void regions to escape from the compressible multilayer article during compression, further reducing the force required to compress the multilayer article. This is in contrast to, for example, a closed cell foam structure which would not allow the gas in the cells of the foam to escape the foam during compression.

FIG. 2D is a schematic cross-sectional side view of a portion of an exemplary compressible multilayer article 230 according to one embodiment of the present disclosure, compressible multilayer article 230 includes polymer layer 10, first primer layer 70, second primer layer 72, first electrode 60 and second electrode 62, as previously described with respect to the description of FIG. 2B. First major surface 10a of silicone polymer layer 10 includes a plurality of precisely shaped first structures 12a, each first structure 12a having a distal end 12a′, wherein at least a portion of the distal ends 12a′ of the plurality of precisely shaped first structures 12a are in contact with and adhered to the first major surface 70a of first primer layer 70. In some embodiments, all of the distal ends 12a′ of the plurality of precisely shaped first structures 12a are in contact with and adhered to the first major surface 20a of first tie-layer 20. First structures 12a have a height H1 and a width W1, as shown in FIG. 2D. Silicon polymer layer 10 includes a land region, which is the portion of the silicon polymer layer that connects the plurality of first structures together, the land region has a height HL.

Second major surface 10b of silicone polymer layer 10 includes a plurality of precisely shaped second structures 12b, each second structure 12b having a distal end 12b′, wherein at least a portion of the distal ends 12b′ of the plurality of precisely shaped second structures 12b are in contact with and adhered to the first major surface 72a of second primer layer 72. In some embodiments, all of the distal ends 12b′ of the plurality of precisely shaped second structures 12b are in contact with and adhered to the first major surface 72a of second primer layer 72. Second structures 12b have a height H2 and a width W2, as shown in FIG. 2D. Silicon polymer layer 10 includes a land region, which is the portion of the silicon polymer layer that connects the plurality of first and second structures together, the land region has a height HL.

Compressible multilayer article 220 also includes first and second void regions 80 and 82, respectively. First and second void regions 80 and 82 are the space or volume between precisely shaped, first structures 12a and precisely shaped second structures 12b. They result from the removal of first substrate 30 having first structures 32 and/or second substrate 40 having second structures 42 from the compressible, multilayer article of FIG. 1C and FIG. 1D, for example. The void regions may contain a gas, e.g. air, nitrogen and the like. The void regions lower the amount of force required to compress the compressible multilayer article in the y-direction, by replacing portions of silicon polymer layer 10 with a material, i.e. a gas, which has a lower compressive modulus than the silicon polymer layer itself. In some embodiments, first and second void regions 80 and 82 may be interconnected to each other and/or may have fluid communication with the atmosphere surrounding the compressible multilayer article. A compressible multilayer article with void regions having fluid communication with the atmosphere surrounding the compressible multilayer article allows the gas in the void regions to escape from the compressible multilayer article during compression, further reducing the force required to compress the multilayer article.

The size, shape and patterns of first void regions 80 and second void regions 82, may be the same or may be different. In some embodiments, at least a portion of first void regions 80 and second void regions 82 may align with one another. In some embodiments, all of first void regions 80 and second void regions 82 may align with one another. In some embodiments, at least a portion of first void regions 80 and second void regions 82 may align with one another. In some embodiments, none of first void regions 80 and second void regions 82 align with one another. The size, shape and patterns of first void regions 80 and second void regions 82, are determined by the size, shape and patterns of first structures 32 and second structures 42, respectively.

FIG. 2E is a schematic cross-sectional side view of a portion of an exemplary compressible multilayer article 240 according to one embodiment of the present disclosure, compressible multilayer article 240 includes silicone polymer layer 10. Silicone polymer layer 10 includes plurality of precisely shaped, discrete structures 10′, each discrete structure 10′ having a first surface 10a′ and opposed second surface 10b′. Discrete structures 10′ have a height, Hd, and a width, Wd, as shown in FIG. 2E. Compressible multilayer article 240 further includes first primer layer 70, having first major surface 70a and second major surface 70b, wherein the first surfaces 10a′ of the plurality of precisely shaped, discrete structures 10 are adhered to and in contact with the first major surface 70a of first primer layer 70. First primer layer 70 may be a continuous sheet, as shown in FIG. 2E or may be discrete regions. In some embodiments, compressible multilayer article 240 may include a second primer layer 72, having first major surface 72a and second major surface 72b, wherein the second surfaces 10b′ of the plurality of precisely shaped, discrete structures 10 are adhered to and in contact with the first major surface 72a of second primer layer 72. Second primer layer 72 may include discrete regions of primer layer 72, corresponding to the discrete structures 10′, as shown in FIG. 2E, or may be a continuous sheet, as shown in FIG. 1A. In some embodiments, first primer layer 70 may be a continuous sheet and second primer layer 72 may be discrete regions, as shown in FIG. 1E. Additionally, a portion of first primer layer 70 and/or second primer layer 72 may be discrete regions and a portion of first primer layer 70 and/or second primer layer 72 may be a continuous sheet that is smaller than the overall area of compressible multilayer article 240.

In some embodiments, the compressible multilayer article 240 may further include a first electrode 60 having a first major surface 60a and a second major surface 60b, wherein first major surface 60a of first electrode 60 is adhered to and in contact with the second major surface 70b of the first primer layer 70; and a second electrode 62 having a first major surface 62a and a second major surface 62b, wherein first major surface 62a of second electrode 62 is adhered to and in contact with the second major surface 72b of the second primer layer 72.

Compressible multilayer article 240 also includes void regions 80. Void regions 80 are the space or volume between precisely shaped, discrete structures 10′. The void region may contain a gas, e.g. air, nitrogen and the like. The void regions lower the amount of force required to compress the compressible multilayer article in the y-direction, by replacing portions of silicon polymer layer 10 with a material, i.e. a gas, which has a lower compressive modulus than the silicon polymer layer itself. In some embodiments, the void regions 80 may be interconnected to each other and/or may have fluid communication with the atmosphere surrounding the compressible multilayer article. A compressible multilayer article with void regions having fluid communication with the atmosphere surrounding the compressible multilayer article allows the gas in the void regions to escape from the compressible multilayer article during compression, further reducing the force required to compress the multilayer article.

### Silicone Polymer Layer

The silicon polymer layer may comprise silicon polymers know in the art. In some embodiments, the silicon polymer has a glass transition temperature less than about −20 degrees centigrade, less than about −30 degrees centigrade less than about −40 degrees centigrade or even less than about −50 degrees centigrade. In some embodiments, the silicon polymer has a glass transition temperature of greater than −150 centigrade. In some embodiments the glass transition temperature of the silicon polymer is between about −150 degrees centigrade and about −20 degrees centigrade, between about −150 degrees centigrade and about −30 degrees centigrade, between about −150 degrees centigrade and about −40 degrees centigrade or even between about −150 degrees centigrade and about −50 degrees centigrade. A glass transition temperature well below room temperature is desired, as the silicon polymer will then be in the rubbery state, as opposed to a glassy state, under normal use conditions. A silicone polymer in the rubbery state will have a lower compression modulus compared to a silicon polymer in the glass state. The lower compression modulus will lead to a lower force required to compress the silicon polymer layer and thus the compressible multilayer article itself.

A rapid, elastic recovery of the silicone polymer layer may be a desirable property of the silicone polymer layer, thus the silicone polymer of the silicone polymer layer may have a rapid, elastic recovery and little viscous dissipation or loss. The ratio of the viscous loss to elastic recovery can be related to the value of the tan delta in a conventional dynamic mechanical thermal analysis test (DMTA). In some embodiments, the tan delta of the silicone polymer of the silicone polymer layer may be between about 0.3 and about 0.0001, between about 0.2 and about 0.0001, between about 0.1 and about 0.0001, between about 0.05 and about 0.0001 or even between about 0.01 and about 0.0001 over a temperature range from about −30 degrees centigrade to about 50 degrees centigrade at a frequency of about 1 Hz.

In some embodiments, the silicon polymer of the silicone polymer layer is at least one of a cured, silicone elastomer or a silicone thermoplastic elastomer. Cured silicone elastomer and silicone thermoplastic elastomer known in the art may be used as the silicon polymer layer. The cured silicone elastomer may include polysiloxanes, including, but not limited to polydimethylsiloxane, polymethylhydrosiloxane, polymethylphenylsiloxane, polysiloxane copolymers, and polysiloxane graft copolymers. The polysiloxanes may be cured by known mechanisms, including but not limited to, addition cure systems, e.g. platinum based cure systems; condensation cure systems, e.g. tin based cure systems, and peroxide based cure systems. A polysiloxane precursor resin, which may be at least one of the polysiloxanes discussed above, which includes a cure system may be cured to form a cured silicone elastomer. The silicone precursor resin may include an optional foaming agent and upon curing may form a cured, silicone elastomer foam. Silicone thermoplastic elastomers, include, but are not limited to polydiorganosiloxane polyoxamide, linear, block copolymers, i.e. silicone polyoxamide, such as those disclosed in U.S. Pat. No. 7,371,464 (Sherman, et. al.) and U.S. Pat. No. 7,501,184 (Leir, et. al.), which is incorporated herein by reference in its entirety. In some embodiments, the silicone polymer layer does not include a tackifier.

In some embodiments, the polymer layer, e.g. the cured, silicone elastomer or silicone thermoplastic elastomer, may be a foam. In some embodiments, the foam has a porosity of from about 20 percent to about 80 percent, from about 25 percent to about 80 percent, from about 30 percent to about 80 percent, from about 20 percent to about 75 percent, from about 25 percent to about 75 percent, from about 30 percent to about 75 percent, from about 20 percent to about 70 percent, from about 25 percent to about 70 percent or even from about 30 percent to about 70 percent. Conventional foaming techniques may be employed, including the use of one or more foaming agents.

When the silicone polymer layer includes a plurality of first structures, second structure or discrete structures, the plurality of structures may be formed by known techniques in the art including, but not limited to, micro-replication techniques. Micro-replication techniques are disclosed in U.S. Pat. Nos. 6,285,001; 6,372,323; 5,152,917; 5,435,816; 6,852,766; 7,091,255 and U.S. Patent Application Publication No. 2010/0188751, all of which are incorporated herein by reference in their entirety. The dimensions, height, width and length of the structures are determined by the mold, embossing tool or production tool used to form them. A textured liner or release liner comprising a polymer, e.g. a thermoplastic polymer or a cured thermoset resin, which includes the inverse pattern of shapes of the desired plurality of structures in one of its major surfaces may be used as a production tool to form the plurality of first structures, second structures and discrete structures.

The shape of the plurality of precisely shaped first, second and discrete structures is not particularly limited and may include, but is not limited to; circular cylindrical; elliptical cylindrical; polygonal prisms, e.g. pentagonal prism, hexagonal prism and octagonal prism; pyramidal and truncated pyramidal, wherein the pyramidal shape may include between 3 to 10 sidewalls; cuboidal; e.g. square cube or rectangular cuboid; conical; truncated conical, annular, spiral and the like. Combinations of shapes may be used. The plurality precisely shaped structures may be arranged randomly across the silicone polymer layer or may be arranged in a pattern, e.g. a repeating pattern. Patterns include, but are not limited to, square arrays, hexagonal arrays and the like. Combination of patterns may be used.

The plurality of precisely shaped first, second and discrete structures may also be in the form of continuous or discontinuous lines. The lines may be straight, curved or wavy and may be parallel, randomly spaced or placed in a pattern. Combinations of different line types and patterns may be used. The cross-sectional shape (the cross-section defined by a plane perpendicular to the length) of the lines is not particularly limited and may include, but is not limited, to triangular, truncated triangular, square, rectangular, trapezoidal, hemi-spherical and the like. Combinations of different cross-sectional shapes may be used.

In some embodiments, the heights, H1 and H2, of the plurality of precisely shaped first and second structures of the silicone polymer layer may be between about 0.5 micron and about 500 micron, between about 2.5 microns and about 500 micron, between about 5 microns and about 500 microns, between about 25 microns and about 500 microns, 0.5 micron and about 375 microns, between about 2.5 microns and about 375 microns, between about 5 microns and about 375 microns, between about 25 microns and about 375 microns, 0.5 micron and about 250 microns, between about 2.5 microns and about 250 microns, between about 5 microns and about 250 microns, between about 25 microns and about 250 microns, 0.1 micron and about 125 microns, between about 2.5 microns and about 125 microns, between about 5 microns and about 125 microns or even between about 25 microns and about 125 microns.

In some embodiments, the height, Hd, of the plurality of precisely shaped, discrete structures of the silicone polymer layer may be between about 1 micron and about 1000 micron, between about 5 microns and about 1000 micron, between about 10 microns and about 1000 microns, between about 50 microns and about 1000 microns, 1 micron and about 750 microns, between about 5 microns and about 750 microns, between about 10 microns and about 750 microns, between about 50 microns and about 750 microns, 1 micron and about 500 microns, between about 5 microns and about 500 microns, between about 10 microns and about 500 microns, between about 50 microns and about 500 microns, 1 micron and about 250 microns, between about 5 microns and about 250 microns, between about 10 microns and about 250 microns or even between about 50 microns and about 250 microns.

In some embodiments, the widths, W1 and W2, of the plurality of precisely shaped first and second structures of the silicone polymer layer, as well as the width, Wd, of the plurality of precisely shaped, discrete structures may be between about 1 micron and about 3000 micron, between about 5 microns and about 3000 microns, between about 10 microns and about 3000 microns, between about 50 microns and about 3000 microns, between about 1 micron and about 2000 micron, between about 5 microns and about 2000 microns, between about 10 microns and about 2000 microns, between about 50 microns and about 2000 microns, between about 1 micron and about 1000 micron, between about 5 microns and about 1000 microns, between about 10 microns and about 1000 microns, between about 50 microns and about 1000 microns, between about 1 micron and about 500 micron, between about 5 microns and about 500 microns, between about 10 microns and about 500 microns or even between about 50 microns and about 500 microns.

In some embodiments, the widths, Wd, of the plurality of engineered first and second structures of the silicone polymer layer, as well as the width, Wd, of the plurality of engineered, discrete structures may be between about 2 micron and about 6000 micron, between about 10 microns and about 6000 microns, between about 20 microns and about 6000 microns, between about 100 microns and about 6000 microns, between about 2 micron and about 4000 micron, between about 10 microns and about 4000 microns, between about 20 microns and about 4000 microns, between about 100 microns and about 4000 microns, between about 2 micron and about 2000 micron, between about 10 microns and about 2000 microns, between about 20 microns and about 2000 microns, between about 100 microns and about 2000 microns, between about 2 micron and about 1000 micron, between about 10 microns and about 1000 microns, between about 20 microns and about 1000 microns or even between about 1000 microns and about 1000 microns.

The lengths, L1 and L2, of the of the plurality of precisely shaped first and second structures, respectively, of the silicone polymer layer, as well as, the length, Ld, of the plurality of precisely shaped, discrete structures is not particularly limited. Although not shown in FIGS. 1C, 1D, 1E, 2C, 2D and 2E, the lengths of these structures would be in the z-direction, in each figure. The lengths may be as long as the length of the compressible multilayer article.

The heights, H1, of the first structures may all be the same or may be different. The heights, H2, of the second structures may all be the same or may be different. The heights, Hd, of the discrete structures may all be the same or may be different. The widths, W1, of the first structures may all be the same or may be different. The widths, W2, of the second structures may all be the same or may be different. The widths, Wd, of the discrete structures may all be the same or may be different. The lengths, L1, of the first structures may all be the same or may be different. The lengths, L2, of the second structures may all be the same or may be different. The lengths, Ld, of the discrete structures may all be the same or may be different.

In some embodiments, the aspect ratios, H1/W1 and H2/W2, of the of the plurality of precisely shaped, first and second structures, respectively, of the silicone polymer layer may be between about 0.05 to about 2.5, between about 0.05 to about 1.5, between about 0.05 to about 1, between about 0.1 to about 0.5, between about 0.1 to about 2.5, between about 0.2 to about 1.5, between about 0.1 to about 1, between about 0.1 to about 0.5, between about 0.15 to about 2.5, between about 0.15 to about 1.5, between about 0.15 to about 1, between about 0.15 to about 0.5, between about 0.2 to about 2.5, between about 0.2 to about 1.5, between about 0.2 to about 1, between about 0.2 to about 0.5,

In some embodiments, the aspect ratio, Hd/Wd, of the of the plurality of precisely shaped, discrete structures of the silicone polymer layer may be between about 0.1 to about 5, between about 0.1 to about 3, between about 0.1 to about 2, between about 0.2 to about 1, between about 0.2 to about 5, between about 0.2 to about 3, between about 0.2 to about 2, between about 0.2 to about 1, between about 0.3 to about 5, between about 0.3 to about 3, between about 0.3 to about 2, between about 0.3 to about 1, between about 0.4 to about 5, between about 0.4 to about 3, between about 0.4 to about 2, between about 0.4 to about 1.

### First Substrate and Second Substrate

The first and second substrates are not particularly limited. In some embodiments, the first and second substrates may be a polymer film, i.e. a liner. The polymer film/liner may include a thermoplastic polymer film including but not limited to polyurethanes; polyalkylenes, e.g. polyethylene and polypropylene; polybutadiene, polyisoprene; polyalkylene oxides, e.g. polyethylene oxide; polyesters, e.g PET and PBT; polyamides; polycarbonates, polystyrenes, block copolymers of any of the proceeding polymers, and combinations thereof. Polymer blends may also be employed. The polymer film/liner may be a release liner. In some embodiments, the polymer film/liner may function as a release liner without the need of a release coating. In other embodiments, the polymer film/liner includes a release coating in order to function as a release liner.

The liner can protect the tie layer during handling and can be easily removed, when desired, for transfer of the multilayered compressible article, or part of the multilayered compressible article to a substrate. Exemplary liners useful for the disclosed article are disclosed in PCT Pat. Appl. Publ. No. WO 2012/082536 (Baran et al.).

The liner may be flexible or rigid. Preferably, it is flexible. A suitable liner is typically at least 0.5 mil thick, and typically no more than 20 mils thick. The liner may be a backing with a release coating disposed on its first surface. Optionally, a release coating can be disposed on its second surface. If this backing is used in an article that is in the form of a roll, the second release coating may have a lower release value than the first release coating. Suitable materials that can function as a rigid liner include metals, metal alloys, metal-matrix composites, metalized plastics, inorganic glasses and vitrified organic resins, formed ceramics, and polymer matrix reinforced composites.

Exemplary liner materials include paper and polymeric materials. For example, flexible backings include densified Kraft paper (such as those commercially available from Loparex North America, Willowbrook, Ill.), poly-coated paper such as polyethylene coated Kraft paper, and polymeric film. Suitable polymeric films include polyester, polycarbonate, polypropylene, polyethylene, cellulose, polyamide, polyimide, polysilicone, polytetrafluoroethylene, polyethylenephthalate, polyvinylchloride, polycarbonate, or combinations thereof. Nonwoven or woven liners may also be useful. Embodiments could incorporate a release coating. CLEARSIL T50 Release liner; silicone coated 2 mil polyester film liner, available from Solutia/CP Films, Martinsville, Va., and LOPAREX 5100 Release Liner, fluorosilicone-coated 2 mil polyester film liner available from Loparex, Hammond, Wis., are examples of useful release liners.

The release coating of the liner may be a fluorine-containing material, a silicon-containing material, a fluoropolymer, a silicone polymer, or a poly(meth)acrylate ester derived from a monomer comprising an alkyl (meth)acrylate having an alkyl group with 12 to 30 carbon atoms. In one embodiment, the alkyl group can be branched. Illustrative examples of useful fluoropolymers and silicone polymers can be found in U.S. Pat. No. 4,472,480 (Olson), U.S. Pat. No. 4,567,073 and U.S. Pat. No. 4,614,667 (both Larson et al.). Illustrative examples of a useful poly(meth)acrylate ester can be found in U.S. Pat. Appl. Publ. No. 2005/118352 (Suwa). The removal of the liner shouldn't negatively alter the surface topology of the tie layer.

The first and second substrates each have a first major surface and a second major surface. In some embodiments, at least one of the first major of the first substrate and first major surface of the second substrate is a textured surface. The textured surface is useful in forming the plurality of precisely shaped first structures, plurality of precisely shaped second structure and the plurality of precisely shaped, discrete structures. The textured surface would typically have the inverse pattern of the structure shapes desired for the final first, second and discrete structures. The inverse pattern of structures may be formed by micro-replication techniques or embossing techniques, known in the art. Micro-replication techniques are disclosed in U.S. Pat. Nos. 6,285,001; 6,372,323; 5,152,917; 5,435,816; 6,852,766; 7,091,255 and U.S. Patent Application Publication No. 2010/0188751, all of which have been incorporated herein by reference in their entirety.

### Primer Layers

The first and second primer layers of the present disclosure may include, but are not limited to, at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes. Combinations of these materials may be used.

In some embodiments, the first and second primer layers include a silicone thermoplastic elastomer, e.g. polydiorganosiloxane polyoxamide, linear, block copolymers, i.e. silicone polyoxamide, such as those disclosed in U.S. Pat. No. 7,371,464 (Sherman, et. al.) and U.S. Pat. No. 7,501,184 (Leir, et. al.), which have been previously been incorporated herein by reference in its entirety. The first and second primer layers that include a silicone thermoplastic elastomer also include a coupling agent. Useful coupling agents include, but are not limited to silane coupling agents (e.g., organotrialkoxysilanes), titanates, zirconates, and organic acid-chromium chlorides coordination complexes. Organosilanes are particularly useful coupling agents In some embodiments, the coupling agent comprises an organosilane coupling agent represented by the formula:

R¹—SiY₃

wherein R¹ is an monovalent organic group and each Y is independently a hydrolyzable group. In some embodiments, R¹ has from 2 to 18 carbon atoms. In some embodiments, R¹ has from 3 to 12 carbon atoms and is selected from the group consisting of epoxyalkyl groups, hydroxyalkyl groups, carboxyalkyl groups, aminoalkyl groups, acryloxyalkyl groups, and methacryloxyalkyl groups. In some embodiments, each Y is independently selected from the group consisting of —Cl, —Br, —OC(═O)R², and OR², wherein R² represents an alkyl group having from 1 to 4 carbon atoms.

Suitable silane coupling agents include, for example, those identified in U.S. Pat. No. 3,079,361 (Plueddemann). Specific examples include: (3-acryloxypropyl)trimethoxysilane, N-(2-aminoethyl)-3-aminopropyltrimethoxysilane, 3-aminopropyltriethoxysilane, 3-aminopropyltrimethoxysilane, (3-glycidoxypropyl)trimethoxysilane, 3-mercaptopropyltrimethoxysilane, 3-methacryloxypropyltrimethoxysilane, vinyltrimethoxysilane (all available from Gelest, Inc., Morrisville, Pa.), and those available under the trade designation “XIAMETER” from Dow Corning Corp., Midland, Mich. such as vinylbenzylaminoethylaminopropyltrimethoxysilane (supplied as 40% in methanol, XIAMETER OF S-6032 SILANE), chloropropyltrimethoxysilane (XIAMETER OF S-6076 SILANE), and aminoethylaminopropyltrimethoxysilane (XIAMETER OF S-6094 SILANE).

Suitable titanate coupling agents include, for example, those identified in U.S. Pat. No. 4,473,671 (Green). Specific examples include isopropyl triisostearoyl titanate, isopropyl tri(lauryl-myristyl) titanate, isopropyl isostearoyl dimethacryl titanate; isopropyl tri(dodecyl-benzenesulfonyl) titanate, isopropyl isostearoyl diacryl titanate, isopropyl tri(diisooctyl phosphato) tri(dioctylpyrophosphato) titanate, isopropyl triacryloyl titanate, and diisopropxy(ethoxyacetoacetyl) titanate, tetra(2,2-diallyoxymethyl)butyl di(ditridecyl)phosphito titanate (available as KR 55 from Kenrich Petrochemicals, Inc. (hereinafter Kenrich) Bayonne, N.J.), neopentyl(diallyl)oxy trineodecanonyl titanate (available as LICA 01 from Kenrich), neopentyl(diallyl)oxy tri(dodecyl)benzene-sulfonyl titanate (available as LICA 09 from Kenrich), neopentyl(diallyl)oxy tri(dioctyl)phosphato titanate (available as LICA 12 from Kenrich), neopentyl(dially)oxy tri(dioctyl)pyrophosphato titanate (available as LICA38 from Kenrich), neopentyl(diallyl)oxy tri(N-ethylenediamino)ethyl titanate (available as LICA 44 from Kenrich), neopentyl(diallyl)oxy tri(m-amino)phenyl titanate (available as LICA 97 from Kenrich), neopentyl(diallyl)oxy trihydroxy caproyl titanate (formerly available as LICA 99 from Kenrich and titanium (IV) butoxide (available from Sigma Aldrich).

Suitable zirconate coupling agents include, for example, those identified in U.S. Pat. No. 4,539,048 (Cohen). Specific examples include zirconium propionate, tetra(2,2-diallyloxymethyl)butyl di(ditridecyl)phosphito zirconate (available as KZ 55 from Kenrich), neopentyl(diallyl)oxy trineodecanoyl zirconate (available as NZ 01 from Kenrich), neopentyl(diallyl)oxy tri(dodecyl)benzenesulfonyl zirconate (available as NZ 09 from Kenrich), neopentyl(diallyl)oxy tri(dioctyl)phosphato zirconate (available as NZ 12 from Kenrich), neopentyl(diallyl)oxy tri(dioctyl)pyrophosphato zirconate (available as NZ 38 from Kenrich), neopentyl(diallyl)oxy tri(N-ethylenediamino)ethyl zirconate (available as NZ 44 from Kenrich), neopentyl(diallyl)oxy tri(m-amino)phenyl zirconate (available as NZ 97 from Kenrich), neopentyl(diallyl)oxy trimethacryl zirconate (available as NZ 33 from Kenrich), neopentyl(diallyl)oxy triacryl zirconate (formerly available as NZ 39 from Kenrich), dineopentyl(diallyl)oxy di(para-aminobenzoyl) zirconate (available as NZ 37 from Kenrich), and dineopentyl(diallyl)oxy di(3-mercapto)propionic zirconate (available as NZ 66A from Kenrich).

Mixtures of one or more coupling agents may be used, although typically a single coupling agent is sufficient. The amount of coupling agent used may be from about 0.1 wt. % to about 30 wt. %, from about 0.1 wt. % to about 25 wt. %, from about 0.1 wt. % to about 20 wt. %, from about 0.1 wt. % to about 15 wt. %, from about 0.1 wt. % to about 10 wt. % or even from about 0.1 wt. % to about 5 wt. % based on the weight of the silicone thermoplastic elastomer.

In some embodiments, the first and second primer layers that include a silicone thermoplastic elastomer may also include tackifier resin. Preferred tackifier resins include silicone tackifier resins referred to as MQ resins, including but not limited to, silicone resin available under the trade designation SILICONE MQ RESINS, from Siltech Corporation, Toronto, Canada and silicon resin available under the trade designation MQ-RESIN POWDER 803 TF, from Wacher Chemie, Munich, Germany. The amount of tackifier resin used may be from about 5 wt. % to about 75 wt % or even 5% to about 50%, based on the weight of the silicone thermoplastic elastomer. In some embodiments, one or both of the first and second primer layer does not include a tackifier.

Commercially available primer layers may also be used, including, but not limited to, 3M ADHESION PROMOTER 111, available form 3M Company, St. Paul, Minn.

In some embodiments, the thickness of the first and second primer layers may be between about 50 nanometers and about 5 microns, between about 200 nanometers and about 5 microns, between about 400 nanometers and about 5 microns, between about 50 nanometers and about 3 microns, between about 200 nanometers and about 3 microns, between about 400 nanometers and about 3 microns, between about 100 nanometers and about 1 micron, between about 200 nanometers and about 1 micron or even between about 400 nanometers and about 1 micron.

The primer layers are typically adhered to and in contact with at least one of an electrode and the silicone polymer layer of the present disclosure. In some embodiments, the primer layer may have a first major surface, wherein the first major surface is adhered to and in contact with a major surface of the silicone polymer layer. In some embodiments, the second major surface of the primer layer is adhered to and in contact with the first major surface of an electrode. In another embodiments, the second major surface of the primer layer is adhered to and in contact with at least one of the passivation layer and the dielectric support substrate of an electrode.

### First and Second Electrodes

The first and second electrodes used in the compressible multilayer articles of the present disclosure may be metals, metal alloys, carbon based, or metal filled polymer, including but not limited to, indium-tin-oxide (ITO), antimony-tin-oxide (ATO), aluminum, copper, silver and gold, nickel, chrome, conductive polymer, carbon, graphene. The electrodes used in the compressible multilayer articles of the present disclosure may be electrically conductive composites containing one or more conductive particles, fibers, woven or non-woven mats and the like. The conductive particles, fibers, woven or non-woven mats may include the above metal. They also may be non-conductive particles, fibers, woven or non-woven mats that have been coated with a conductive material, e.g. a metal, including but not limited to, aluminum, copper, silver and gold. The electrodes used in the force-sensing capacitor elements may be in the form of thin films, e.g. a thin metal film or thin electrically conductive composite film. The thickness of the electrodes may be between about 0.1 microns and about 200 microns. The thickness may be greater than about 0.5 microns, greater than about 1 microns, greater than about 2 microns, greater than about 3 microns, greater than about 4 microns or even greater than about 5 microns; less than about 50, less than about 40 microns, less than about 30 microns, less than about 20 microns, or even less than 10 microns. The electrodes may be fabricated by know techniques in the art including, but not limited to, techniques commonly used to form indium-tin-oxide traces in present touch screen displays and techniques commonly used to form metal lines and vias in semiconductor manufacturing. Other useful techniques for fabricating the electrodes include screen printing, flexographic printing, inkjet printing, photolithography, etching, and lift-off processing.

The first and second electrodes may be multilayer electrodes that include two or more layers of conductive materials, as described above. The electrodes may also include one or more of the following: substrate layers, e.g. dielectric support substrate, insulating layers, adhesive layers, passivation layers, barrier layers, cover coats, protective coatings, and the like. These layers may be in any order. The electrodes may also include a passivation layer on at least a portion of their surface. Passivation layers, e.g. a cover coat or layer, know in the art may be used. The passivation layers may be organic or inorganic materials that may be electrically insulating. Passivation layers include, but are not limited to, acrylics, polyurethanes, acylated polyurethanes, polyeters, copolyesters, polyimides, epoxies and acrylated epoxies. Combinations of these materials may be used. Adhesives may be used to bond the films to the electrically conductive substrate of the electrode, including, but not limited to, polyester adhesive, acrylic adhesive and epoxy adhesive. The electrode may also include a support substrate, e.g. a polymeric support substrate, for example, polyesters (PET) or polyether ether ketone, (PEEK), polyimide (PI), polyethylene napthalate (PEN), Polyetherimide (PEI), along with various fluropolymers (FEP) and copolymers. The electrodes may also include one or more of the following: substrate layers, insulating layers, adhesive layers, passivation layers, barrier layers, cover coats, protective coatings, and the like. These layers may be in any order. In some embodiments, the first and/or second electrode may include at least one of a passivation layer and a dielectric support substrate.

The compressible multilayer articles of the present disclosure can be fabricated by conventional techniques, including, but not limited to conventional lamination techniques that include heat and/or pressure, conventional coating techniques, e.g. coating a solvent solution of a polymer followed by removing the solvent, conventional extrusions techniques and combinations thereof.

Lamination techniques include batch and continuous process. A batch process may involve a conventional heated press, wherein two or more substrates to be laminated are stacked within the press with the appropriate surfaces facing one another. Heat and/or pressure may then be applied to the substrates for the required time, thereby laminating the substrates together. A continuous laminating process may include running continuous films of two or more substrates, with their appropriate surfaces facing one another, through a pair of cylindrical rolls. The rolls may include a constant force applied to them, which creates a constant pressure applied to the substrate surfaces as they pass between the rolls, or the rolls may be set to have a constant nip, i.e. gap, which also creates a force and subsequent pressure on the substrates as they proceed through the nip of the rolls. One or both of the rolls may be heated to the desired temperature, to facilitate the lamination process.

Illustrative coating techniques include roll coating, spray coating, knife coating, die coating, Meyer rod coating and the like. A specific coating techniques is selected based on a variety of factors, including but not limited to, the material being coated, the desired final coating thickness, process consideration, e.g. continuous or batch, and the like. A coating composition is typically applied to a substrate under ambient conditions but may also be applied under conditions of elevated temperature (e.g. 30-70° C.). Depending on the material being coated, it can be coated with or without solvent added as a diluent or viscosity modifier. For example, polysiloxane precursor resin may be coated without solvent, if the molecular weight of the precursor resin is low enough to enable such a coating approach. A cured, silicone eleastomer may then be directly formed from the coating by curing the precursor resin. A polysiloxane precursor resin may include one or more solvents, for example to lower its viscosity, and then be coated. The solvent may be removed by a drying process at ambient or elevated temperatures, and the polysiloxane precursor resin may then be cured to form a cured, silicone elastomer. In one embodiment, the present disclosure provides a method of making a compressible, multilayer article, including providing a silicone polymer layer having a first major surface and a second major surface; applying a first primer layer to the first major surface of the silicone polymer layer, wherein the thickness of the first primer layer is from about 100 nanometers to about 100 microns. The method may further include applying a second primer layer to the second major surface of the silicone polymer layer, wherein the thickness of the second primer layer is from about 100 nanometers to about 100 microns. In some embodiments, the method may further include providing a first electrode having a first major surface and a second major surface and laminating the first major surface of the first electrode to the exposed surface of the first primer layer. In some embodiments, the method may further include providing a first electrode having a first major surface and a second major surface and a second electrode having a first major surface and a second major surface; laminating the first major surface of the first electrode to the exposed surface of the first primer layer; and laminating the first major surface of the second electrode to the exposed surface of the second primer layer.

In another embodiment, the present disclosure provides a method of making a compressible, multilayer article, including providing a first electrode having a first major surface and a second major surface; applying a first primer layer to the first major surface of the first electrode, wherein the thickness of the first primer layer is from about 100 nanometers to about 100 microns; providing a silicone polymer layer having a first major surface and second major surface; and laminating the first major surface of the silicon polymer layer to the exposed surface of the first primer layer. The method may further include providing a second electrode having a first major surface and a second major surface; applying a second primer layer to the first major surface of the second electrode, wherein the thickness of the second primer layer is from about 100 nanometers to about 100 microns, and laminating the second major surface of the silicone polymer layer to the exposed surface of the second primer layer.

The methods of making the compressible, multilayer article, may include any of the silicone polymer layers, first and second electrodes, first and second primer layers and first and second substrates described herein, as well as, their corresponding materials.

Select embodiments of the present disclosure include, but are not limited to, the following:

In a first embodiment, the present disclosure provides a compressible, multilayer article comprising: a silicone polymer layer having a first major surface and a second major surface; and a first primer layer having a first major surface and a second major surface, wherein the thickness of the first primer layer is from about 100 nanometers to about 100 microns and at least a portion of the first major surface of the first primer layer is adhered to and in contact with the first major surface of the silicone polymer.

In a second embodiment, the present disclosure provides a compressible, multilayer article according to the first embodiment, wherein the silicone polymer layer is a foam.

In a third embodiment, the present disclosure provides a compressible, multilayer article according to the second embodiment, wherein the silicone polymer layer foam has a porosity of between about 20 percent to about 80 percent.

In a fourth embodiment, the present disclosure provides a compressible, multilayer article according to any one of the first through third embodiments, wherein the silicone polymer layer is at least one of a cured, silicone elastomer and a silicone thermoplastic elastomer.

In a fifth embodiment, the present disclosure provides a compressible, multilayer article according to the fourth embodiment, wherein the silicone polymer layer is a silicone thermoplastic elastomer comprising silicone polyoxamide.

In a sixth embodiment, the present disclosure provides a compressible, multilayer article according to any one of the first through fifth embodiments, further comprising a second primer layer having a first major surface and a second major surface, wherein the thickness of the second primer layer is from about 100 nanometers to about 100 microns and at least a portion of the first major surface of the second primer layer is adhered to and in contact with the second major surface of the silicone polymer.

In a seventh embodiment, the present disclosure provides a compressible, multilayer article according to any one of the first through sixth embodiments, wherein the first primer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes.

In an eighth embodiment, the present disclosure provides a compressible, multilayer article according to the sixth embodiment, wherein the first primer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes.

In a ninth embodiment, the present disclosure provides a compressible, multilayer article according to any one of the first through eighth embodiments, wherein the first major surface of the silicone polymer layer includes a plurality of precisely shaped first structures, each structure having a distal end, wherein at least a portion of the distal ends of the plurality of precisely shaped first structures are in contact with and adhered to the first major surface of the first primer layer.

In a tenth embodiment, the present disclosure provides a compressible, multilayer article according to the sixth or eighth embodiments, wherein the first major surface of the silicone polymer layer includes a plurality of precisely shaped first structures and the second major surface of the silicone polymer layer includes a plurality of precisely shaped second structures, each structure having a distal end, wherein at least a portion of the distal ends of the plurality of precisely shaped first structures are in contact with and adhered to the first major surface of the first primer layer and at least a portion of the distal ends of the plurality of precisely shaped second structures are in contact with and adhered to the first major surface of the second primer layer.

In an eleventh embodiment, the present disclosure provides a compressible, multilayer article according to the sixth or eighth embodiments, wherein the polymer layer comprises a plurality of precisely shaped, discrete structures, each discrete structure having a first surface and opposed second surface, wherein the first surfaces of the plurality of precisely shaped, discrete structures are adhered to and in contact with the first major surface of the first primer layer and the second surfaces of the plurality of precisely shaped, discrete structures are adhered to and in contact with the first major surface of the second primer layer.

In a twelfth embodiment, the present disclosure provides a compressible, multilayer article comprising:

a silicone polymer layer having a first major surface and a second major surface;

a first primer layer having a first major surface and a second major surface, wherein the thickness of the first primer layer is from about 100 nanometers to about 100 microns and the first major surface of the first primer layer is adhered to and in contact with the first major surface of the silicone polymer; and a first electrode having a first major surface and a second major surface, wherein the first major surface of the first electrode is adhered to and in contact with the second major surface of the first primer layer.

In a thirteenth embodiment, the present disclosure provides a compressible, multilayer article according to the twelfth embodiment, wherein the silicone polymer is a foam.

In a fourteenth embodiment, the present disclosure provides a compressible, multilayer article according to the thirteenth embodiment, wherein the silicone polymer foam has a porosity of between about 20 percent to about 80 percent.

In a fifteenth embodiment, the present disclosure provides a compressible, multilayer article according to any one of the twelfth through fourteenth embodiments, wherein the silicone polymer is at least one of a cured, silicone elastomer and a silicone thermoplastic elastomer.

In a sixteenth embodiment, the present disclosure provides a compressible, multilayer article according to the fifteenth embodiment, wherein the silicone polymer layer is a silicone thermoplastic elastomer comprising silicone polyoxamide.

In a seventeenth embodiment, the present disclosure provides a compressible, multilayer article according to any one of the twelfth through sixteenth embodiments, further comprising a second primer layer having a first major surface and a second major surface, wherein the thickness of the second primer layer is from about 100 nanometers to about 100 microns and the first major surface of the second primer layer is adhered to and in contact with the second major surface of the silicone polymer; and a second electrode having a first major surface and a second major surface, wherein the first major surface of the second electrode is adhered to and in contact with the second major surface of the second primer layer.

In an eighteenth embodiment, the present disclosure provides a compressible, multilayer article according to the twelfth through seventeenth embodiments, wherein the first primer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxane.

In a nineteenth embodiment, the present disclosure provides a compressible, multilayer article according to the seventeenth embodiment, wherein the first primer layer and second primer layer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxane.

In a twentieth embodiment, the present disclosure provides a compressible, multilayer article according to any one of the twelfth through nineteenth embodiments, wherein the first major surface of the silicone polymer layer includes a plurality of precisely shaped first structures, each structure having a distal end, wherein at least a portion of the distal ends of the plurality of precisely shaped first structures are in contact with and adhered to the first major surface of the first primer layer.

In a twenty-first embodiment, the present disclosure provides a compressible, multilayer article according to the seventeenth embodiment, wherein the first major surface of the silicone polymer layer includes a plurality of precisely shaped first structures and the second major surface of the silicone polymer layer includes a plurality of precisely shaped second structures, each structure having a distal end, wherein at least a portion of the distal ends of the plurality of precisely shaped first structures are in contact with and adhered to the first major surface of the first primer layer and at least a portion of the distal ends of the plurality of precisely shaped second structures are in contact with and adhered to the first major surface of the second primer layer.

In a twenty-second embodiment, the present disclosure provides a compressible, multilayer article according to any one of the twelfth through twenty-first embodiments, wherein the first electrode comprises at least one of copper, nickel, chrome, aluminum, silver, gold, conductive polymer, ITO, ATO, carbon and graphene.

In a twenty-third embodiment, the present disclosure provides a compressible, multilayer article according to the twenty-second embodiment, wherein the first electrode further comprises at least one of a passivation layer and a dielectric support substrate.

In a twenty-fourth embodiment, the present disclosure provides a compressible, multilayer article according to the twenty-third embodiment, wherein the second major surface of the first primer layer is adhered to and in contact with at least one of the passivation layer and the dielectric support substrate of the electrode.

In a twenty-fifth embodiment, the present disclosure provides a compressible, multilayer article according to the seventeenth, nineteenth and twenty-first embodiments, wherein the first and second electrode comprises at least one of copper, nickel, chrome, aluminum, silver, gold, conductive polymer, ITO, ATO, carbon and graphene.

In a twenty-sixth embodiment, the present disclosure provides a compressible, multilayer article according to the twenty-fifth embodiment, wherein at least one of the first and second electrode further comprises at least one of a passivation layer and a dielectric support substrate.

In a twenty-seventh embodiment, the present disclosure provides a compressible, multilayer article according to the twenty-sixth embodiment, wherein at least one of the second major surface of the first primer layer and the second major surface of the second primer layer is adhered to and in contact with at least one of the passivation layer and the dielectric support substrate of the electrode.

In a twenty-eighth embodiment, the present disclosure provides a compressible, multilayer article according to the seventeenth, nineteenth and twenty-fifth through twenty-seventh embodiments, wherein the polymer layer comprises a plurality of precisely shaped, discrete structures, each discrete structure having a first surface and opposed second surface, wherein the first surfaces of the plurality of precisely shaped, discrete structures are adhered to and in contact with the first major surface of the first primer layer and the second surfaces of the plurality of precisely shaped, discrete structures are adhered to and in contact with the first major surface of the second primer layer.

In a twenty-ninth embodiment, the present disclosure provides a method of making a compressible, multilayer article comprising:

providing a silicone polymer layer having a first major surface and a second major surface;

applying a first primer layer to the first major surface of the silicone polymer layer, wherein the thickness of the first primer layer is from about 100 nanometers to about 100 microns.

In a thirtieth embodiment, the present disclosure provides a method of making a compressible, multilayer article according to the twenty-ninth embodiment, further comprising:

applying a second primer layer to the second major surface of the silicone polymer layer, wherein the thickness of the second primer layer is from about 100 nanometers to about 100 microns.

In a thirty-first embodiment, the present disclosure provides a method of making a compressible, multilayer article according to the twenty-ninth or thirtieth embodiments, further comprising providing a first electrode having a first major surface and a second major surface and laminating the first major surface of the first electrode to the exposed surface of the first primer layer.

In a thirty-second embodiment, the present disclosure provides a method of making a compressible, multilayer article according to the thirtieth embodiment, further comprising providing a first electrode having a first major surface and a second major surface and a second electrode having a first major surface and a second major surface; laminating the first major surface of the first electrode to the exposed surface of the first primer layer; and laminating the first major surface of the second electrode to the exposed surface of the second primer layer.

In a thirty-third embodiment, the present disclosure provides a method of making a compressible, multilayer article comprising:

providing a first electrode having a first major surface and a second major surface;

applying a first primer layer to the first major surface of the first electrode, wherein the thickness of the first primer layer is from about 100 nanometers to about 100 microns;

providing a silicone polymer layer having a first major surface and second major surface; and

laminating the first major surface of the silicon polymer layer to the exposed surface of the first primer layer.

In a thirty-fourth embodiment, the present disclosure provides a method of making a compressible, multilayer article according to the thirty-third embodiment, further comprising providing a second electrode having a first major surface and a second major surface; applying a second primer layer to the first major surface of the second electrode, wherein the thickness of the second primer layer is from about 100 nanometers to about 100 microns; and laminating the second major surface of the silicone polymer layer to the exposed surface of the second primer layer.

In a thirty-fifth embodiment, the present disclosure provides a method of making a compressible, multilayer article according to any one of the thirty-first through thirty-fourth embodiments, wherein at least one of the first and second electrode comprises at least one of copper, nickel, chrome, aluminum, silver, gold, conductive polymer, ITO, ATO, carbon and graphene.

In a thirty-sixth embodiment, the present disclosure provides a method of making a compressible, multilayer article according to any one of the thirty-first through thirty-fifth embodiments, wherein at least one of the first and second electrode further comprises at least one of a passivation layer and a dielectric support substrate.

In a thirty-seventh embodiment, the present disclosure provides a method of making a compressible, multilayer article according to any one of the thirty-first through thirty-sixth embodiments, wherein at least one of the second major surface of the first primer layer and the second major surface of the second primer layer is adhered to and in contact with at least one of the passivation layer and the dielectric support substrate of the electrode.

In a thirty-eighth embodiment, the present disclosure provides a method of making a compressible, multilayer article according to any one of the twenty-ninth through thirty-seventh embodiments, wherein the silicone polymer layer is a foam layer.

In a thirty-ninth embodiment, the present disclosure provides a method of making a compressible, multilayer article according to thirty-eighth embodiment, wherein the silicone polymer layer foam has a porosity of between about 20 percent to about 80 percent.

In a fortieth embodiment, the present disclosure provides a method of making a compressible, multilayer article according to any one of the twenty-ninth through thirty-ninth embodiments, wherein the silicone polymer layer is at least one of a cured, silicone elastomer and a silicone thermoplastic elastomer.

In a forty-first embodiment, the present disclosure provides a method of making a compressible, multilayer article according to the fortieth embodiment, wherein the silicone polymer layer is a silicone thermoplastic elastomer comprising silicone polyoxamide.

In a forty-second embodiment, the present disclosure provides a method of making a compressible, multilayer article according to any one of the twenty-ninth through forty-first embodiments, wherein at least one of the first major surface and the second major surface of the silicone polymer layer includes a plurality of precisely shaped first structures.

In a forty-third embodiment, the present disclosure provides a method of making a compressible, multilayer article according to any one of the twenty-ninth through forty-first embodiments, wherein both the first major surface and the second major surface of the silicone polymer layer includes a plurality of precisely shaped first structures and second structures, respectively.

In a forty-fourth embodiment, the present disclosure provides a method of making a compressible, multilayer article according to any one of the twenty-ninth through forty-first embodiments, wherein the silicone polymer layer comprises a plurality of discrete structures.

### Examples

### Materials

Materials

| Abbreviation | |
|---|---|
| or Trade Name | Description |
| 15k SPOx | A silicone polyoxamide with an average diamine |
| | molecular weight of about 15,000 g/mole that was |
| | prepared as described in U.S. Pat. No. U.S. Pat. |
| | No. 7,501,184, available from 3M Company, St. |
| | Paul, Minnesota, upon request. |
| 5k SPOx | A silicone polyoxamide with an average diamine |
| | molecular weight of about 5,000 g/mole that was |
| | prepared as described in U.S. Pat. No. U.S. Pat. |
| | No. 7,501,184, available from 3M Company, upon |
| | request. |
| SR545 | A siloxane tackifier, available under the trade |
| | designation “SR545”, from Momentive, Waterford, |
| | New York. |
| 803 TF | A silicon resin available under the trade designation |
| | MQ- RESIN POWDER 803 TF, from Wacher Chemie, |
| | Munich, Germany |
| AP111 | Primer, available under the trade designation “3M |
| | ADHESION PROMOTER 111”, from 3M Company. |
| ATES | A silane coupling agent, aminopropyl triethoxy silane, |
| | available from Sigma Aldrich, St Louis, MO, USA |
| PET-1 | Primed 3 mil (76 micron) thick PET film (available under |
| | the trade designation LOPAREX from 3M Company). |
| PET-2 | Primed 2 mil (51 micron) thick PET film (available under |
| | the trade designation LOPAREX from 3M Company). |

### Test Methods

### Adhesion Force-T-Peel

Peel adhesion force is defined as the average load per unit width of bondline required to separate progressively a flexible member from a rigid member or another flexible member, measured at a specific angle and rate. The methods of sample preparation and testing are modifications of ASTM method D 1876-08, Standard Test Method for Peel Resistance of Adhesives. Prior to testing, the samples were equilibrated at a constant temperature of 23° C. and relative humidity of 50%, for twenty four hours. The samples are cut into 10 millimeter wide strips. Peel adhesion is measured as a 180 degree peel back at a crosshead speed of 300 mm/min using MTS Instron (MTS Systems Corp, Eden Prairie, Minn.). The peel adhesion force is reported as an average of three to ten replicates, in Newtons/mm.

### Polymer Layer 1 (PL-1)

9.7 lb/hr (4.4 Kg/hr) of Silicone Polyoxamide (silicone thermoplastic elastomer) was fed into a twin-screw extruder which was connected by a necktube to an extrusion die. A progressive temperature profile was utilized with a peak temperature of 475° F. (246° C.) in the die. The resultant 8 mil (203 micron) foamed web was extrusion coated onto a PET liner and run across an 80° F. (27° C.) chill roll. The resultant article was wound up on winding station.

### Polymer Layer 2 (PL-2)

9.7 lb/hr (4.4 kg/hr) of Silicone Polyoxamide (silicone thermoplastic elastomer) and 0.3 lb/hr (0.14 Kg/hr) of Reed FPE-50 (a chemical nucleating and foaming agent available from Reedy International) were fed into a twin-screw extruder which was connected by a necktube to an extrusion die. A progressive temperature profile was utilized with a peak temperature of 475° F. (246° C.) in the die. The resultant 8 mil foamed web was extrusion coated onto a PET liner and run across an 80° F. (27° C.) chill roll. The resultant article was wound up on winding station.

### Polymer Layer 3 (PL-3)

The cast web in this example was produced using the manufacturing set-ups described in U.S. Pat. Publ. No. 20130009336, which is incorporated herein by reference in its entirety. A plurality of the flow channels were positioned in the repeat pattern as shown in FIG. 27 of U.S. Pat. Publ. No. 20130009336. A first plurality of flow channels (feed stream A) is positioned adjacent to a second plurality of flow channels (feed stream B) in the horizontal direction. A third plurality of flow channels (feed stream C) is placed adjacent vertically (below) the second plurality of flow channels, while a fourth plurality of flow channels (feed stream D) is positioned horizontally adjacent to the third plurality of flow channels and vertically adjacent (below) the first plurality of flow channels. The flow channels of feed streams A and D were 4 mils (102 micron) in width, while the flow channels for feed streams B and C were 12 mils (305 microns) wide and the heights of the flow channels varied between 15 and 30 mils (380 and 760 microns).

Silicone Polyoxamide, as described in U.S. Pat. No. 7,501,184, having the chemical formula I:

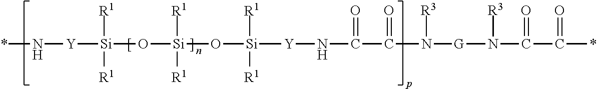

where R1 is —CH3, R3 is —H, G is —CH2CH2-, n is ˜335, p=1, Y is —CH2CH2CH2- (available from 3M company, St. Paul, Minn.) was fed into feed stream A at 0.75 lb/hr (0.34 kg/hr), while VISTAMAXX™ 3980 (Ethylene/PP copolymer) (available from ExxonMobil Chemical, Houston, Tex.) was fed into feed stream B at 1.2 lb/hr (0.54 kg/hr) and VISTAMAXX™ 6202 was fed into feedstreams C and D at 1 lb/hr (0.45 kg/hr) and 0.75 lb/hr (0.34 kg/hr), respectively. The resultant cast web yielded a series of filament structures of flow channel A which averaged 267 microns in height, 158 microns in width, with an average spacing of 348 microns between structures, and an overall cast web height of 457.5 microns.

### Primer Coating Solution (PCS-1)

In an 8 oz jar, 21.6 grams of a 5% by weight 5 k SPOx solution in a 70/30 toulene/isopropyl alcohol blend was mixed with 0.612 grams by weight Wacker 803TF. ATES, 0.174 grams, was added. The jar was rolled for at least 10 minutes to mix the components.

### Primer 2 Coating Solution (PCS-2)

In a second 8 oz jar, 28.3 grams of a 5% by weight 15 k SPOx solution in a 70/30 toulene/isopropyl alcohol blend was mixed with 1.24 grams of a 61.5% by weight SR545 solution in toluene. ATES, 0.24 grams, was added. The jar was rolled for 10 minutes to mix the components.

### Example 1

A meyer rod was used to apply 5 grams of PCS-2 to a first major surface of PL-1. The PCS-2 coating was allowed to dry at 85° C. for at least one minute, forming a first primer layer, of about 5 microns in thickness on PL-1. A piece of 3 mil (76 micron) thick PET-1 was then laminated to the exposed surface of the first primer layer of PL-1, using a roller and slight hand pressure. Using the same meyer rod, the second major surface of PL-1 was coated with 5 grams of PCS-2. The PCS-2 coating was allowed to dry at 85° C. for at least one minute, forming a second primer layer on PL-1. A piece of 3 mil (76 micron) thick PET-1 was then laminated to the exposed surface of the second primer layer of PL-1, using a roller and slight hand pressure. The entire laminate was heated at 120° C. for 2 minutes, producing a compressible, multilayer article, Example 1.

### Example 2

A meyer rod was used to apply 5 grams of PCS-1 directly to a first major surface of a piece of PET-1. The PCS-1 coating was allowed to dry at 85° C. for at least one minute, forming primer layer of about 0.5 microns in thickness on PET-1. The exposed surface of the primer layer of PET-1 was then laminated to the first major surface of a piece of PL-2, using a roller and slight hand pressure. A second piece of PET-1 was then coated with PCS-1 and dried, as described above. The exposed surface of the primer layer of the second PET-1 film was then laminated to the second major surface of the piece of PL-2. The entire laminate was heated at 85° C. for 19 hours, producing a compressible, multilayer article, Example 1.

### Example 3

A meyer rod was used to apply 5 grams of Adhesion Promoter 111 directly to a first major surface of a piece of PET-1. The Adhesion Promoter 111 coating was allowed to dry at 85° C. for at least one minute, forming primer layer of about 2.5 microns in thickness on PET-1. The exposed surface of the primer layer of PET-1 was then laminated to the first major surface of a piece of PL-2, using a roller and slight hand pressure. A second piece of PET-1 was then coated with Adhesion Promoter 111 and dried, as described above, forming a primer layer of about 2.5 microns in thickness. The exposed surface of the primer layer of the second PET-1 film was then laminated to the second major surface of the piece of PL-2. The entire laminate was heated at 85° C. for 15 minutes, producing a compressible, multilayer article, Example 2. The primer layer thickness was about 1 micron.

### Example 4

A meyer rod was used to apply 5 grams of Adhesion Promoter 111 directly to a first major surface of a piece of PET-1. The Adhesion Promoter 111 coating was allowed to dry at 85° C. for at least one minute, forming primer layer of about 0.5 micron in thickness on PET-1. The exposed surface of the primer layer of PET-1 was then laminated to the first major surface of a piece of PL-1, using a roller and slight hand pressure. A second piece of PET-1 was then coated with Adhesion Promoter 111 and dried, as described above. The exposed surface of the primer layer of the second PET-1 film was then laminated to the second major surface of the piece of PL-1. The entire laminate was heated at 120° C. for 2 minutes, producing a compressible, multilayer article, Example 2.

### Example 5

Adhesion Promoter 111 was solution coated directly on to a first major surface of a piece of PET-1. The Adhesion Promoter 111 coating was allowed to dry at 85° C. for at least one minute, forming primer layer on PET-2. Two sheets were cut from the roll, forming two primer layer PET-2. The exposed surface of the primer layer of PET-2 was then laminated to the first major surface of a piece of PL-3, using a roller and slight hand pressure. The laminate was heated at 85° C. for three minutes. A second piece of PET-2 was then coated with Adhesion Promoter 111 and dried, as described above. The exposed surface of the primer layer of the second PET-1 film was then laminated to the second major surface of the piece of PL-3.

TABLE 1
Adhesion Force Properties

| | Average Peel Force | |
|---|---|---|
| Example | (N/mm) | Mode of Failure |
| 1 | 0.058 | adhesive |
| 2 | 0.242 | adhesive |
| 3 | 0.173 | cohesive |
| 4 | 1.070 | adhesive |
| 5 | 0.011 | adhesive |

1) A compressible, multilayer article comprising:
a silicone polymer layer having a first major surface and a second major surface; and
a first primer layer having a first major surface and a second major surface, wherein the thickness of the first primer layer is from about 100 nanometers to about 100 microns and at least a portion of the first major surface of the first primer layer is adhered to and in contact with the first major surface of the silicone polymer.

2) The compressible, multilayer article of claim 1, wherein the silicone polymer layer is a foam.

3) The compressible, multilayer article of claim 2, wherein the silicone polymer layer foam has a porosity of between about 20 percent to about 80 percent.

4) The compressible, multilayer article of claim 1, wherein the silicone polymer layer is at least one of a cured, silicone elastomer and a silicone thermoplastic elastomer.

5) The compressible, multilayer article of claim 4, wherein the silicone polymer layer is a silicone thermoplastic elastomer comprising silicone polyoxamide.

6) The compressible, multilayer article of claim 1, further comprising a second primer layer having a first major surface and a second major surface, wherein the thickness of the second primer layer is from about 100 nanometers to about 100 microns and at least a portion of the first major surface of the second primer layer is adhered to and in contact with the second major surface of the silicone polymer.

7) The compressible, multilayer article of claim 1, wherein the first primer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes.

8) The compressible, multilayer article of claim 6, wherein the first primer layer and second primer layer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes.

9) The compressible, multilayer article of claim 1, wherein the first major surface of the silicone polymer layer includes a plurality of precisely shaped first structures, each structure having a distal end, wherein at least a portion of the distal ends of the plurality of precisely shaped first structures are in contact with and adhered to the first major surface of the first primer layer.

10) The compressible, multilayer article of claim 6, wherein the first major surface of the silicone polymer layer includes a plurality of precisely shaped first structures and the second major surface of the silicone polymer layer includes a plurality of precisely shaped second structures, each structure having a distal end, wherein at least a portion of the distal ends of the plurality of precisely shaped first structures are in contact with and adhered to the first major surface of the first primer layer and at least a portion of the distal ends of the plurality of precisely shaped second structures are in contact with and adhered to the first major surface of the second primer layer.

11) The compressible, multilayer article of claim 6, wherein the polymer layer comprises a plurality of precisely shaped, discrete structures, each discrete structure having a first surface and opposed second surface, wherein the first surfaces of the plurality of precisely shaped, discrete structures are adhered to and in contact with the first major surface of the first primer layer and the second surfaces of the plurality of precisely shaped, discrete structures are adhered to and in contact with the first major surface of the second primer layer.

12) A compressible, multilayer article comprising:
a silicone polymer layer having a first major surface and a second major surface;
a first primer layer having a first major surface and a second major surface, wherein the thickness of the first primer layer is from about 100 nanometers to about 100 microns and the first major surface of the first primer layer is adhered to and in contact with the first major surface of the silicone polymer; and
a first electrode having a first major surface and a second major surface, wherein the first major surface of the first electrode is adhered to and in contact with the second major surface of the first primer layer.

13) The compressible, multilayer article of claim 12, wherein the silicone polymer is a foam.

14) The compressible, multi-layer article of claim 13, wherein the silicone polymer foam has a porosity of between about 20 percent to about 80 percent.

15) The compressible, multilayer article of claim 12, wherein the silicone polymer is at least one of a cured, silicone elastomer and a silicone thermoplastic elastomer.

16) The compressible, multilayer article of claim 15, wherein the silicone polymer layer is a silicone thermoplastic elastomer comprising silicone polyoxamide.

17) The compressible, multilayer article of claim 12, further comprising
a second primer layer having a first major surface and a second major surface, wherein the thickness of the second primer layer is from about 100 nanometers to about 100 microns and the first major surface of the second primer layer is adhered to and in contact with the second major surface of the silicone polymer; and
a second electrode having a first major surface and a second major surface, wherein the first major surface of the second electrode is adhered to and in contact with the second major surface of the second primer layer.

18) The compressible, multilayer article of claim 12, wherein the first primer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes.

19) The compressible, multilayer article of claim 17, wherein the first primer layer and second primer layer includes at least one of silicone thermoplastic elastomer, e.g., silicone polyoxamide, olefin and styrene based block copolymer, e.g. styrene-ethylene-butadiene-styrene and styrene-isoprene-styrene, polyacrylates, e.g. polyester acrylate and polyurethane acrylate, fumed silica, functionalized fumed silica, silanes, titinates, zirconates and siloxanes.

20) The compressible, multilayer article of claim 12, wherein the first major surface of the silicone polymer layer includes a plurality of precisely shaped first structures, each structure having a distal end, wherein at least a portion of the distal ends of the plurality of precisely shaped first structures are in contact with and adhered to the first major surface of the first primer layer.

21) The compressible, multilayer article of claim 17, wherein the first major surface of the silicone polymer layer includes a plurality of precisely shaped first structures and the second major surface of the silicone polymer layer includes a plurality of precisely shaped second structures, each structure having a distal end, wherein at least a portion of the distal ends of the plurality of precisely shaped first structures are in contact with and adhered to the first major surface of the first primer layer and at least a portion of the distal ends of the plurality of precisely shaped second structures are in contact with and adhered to the first major surface of the second primer layer.

22) The compressible, multilayer article of claim 12, wherein the first electrode comprises at least one of copper, nickel, chrome, aluminum, silver, gold, conductive polymer, ITO, ATO, carbon and graphene.

23) The compressible, multilayer article of claim 22, wherein the first electrode further comprises at least one of a passivation layer and a dielectric support substrate.

24) The compressible, multilayer article of claim 23, wherein the second major surface of the first primer layer is adhered to and in contact with at least one of the passivation layer and the dielectric support substrate of the electrode.

25) The compressible, multilayer article of claim 17, wherein the first and second electrode comprises at least one of copper, nickel, chrome, aluminum, silver, gold, conductive polymer, ITO, ATO, carbon and graphene.

26) The compressible, multilayer article of claim 25, wherein at least one of the first and second electrode further comprises at least one of a passivation layer and a dielectric support substrate.

27) The compressible, multilayer article of claim 26, wherein at least one of the second major surface of the first primer layer and the second major surface of the second primer layer is adhered to and in contact with at least one of the passivation layer and the dielectric support substrate of the electrode.

28) The compressible, multilayer article of claim 17, wherein the polymer layer comprises a plurality of precisely shaped, discrete structures, each discrete structure having a first surface and opposed second surface, wherein the first surfaces of the plurality of precisely shaped, discrete structures are adhered to and in contact with the first major surface of the first primer layer and the second surfaces of the plurality of precisely shaped, discrete structures are adhered to and in contact with the first major surface of the second primer layer.

29) A method of making a compressible, multilayer article comprising:
providing a silicone polymer layer having a first major surface and a second major surface;
applying a first primer layer to the first major surface of the silicone polymer layer, wherein the thickness of the first primer layer is from about 100 nanometers to about 100 microns.

30) The method of making a compressible, multilayer article of claim 29, further comprising:
applying a second primer layer to the second major surface of the silicone polymer layer, wherein the thickness of the second primer layer is from about 100 nanometers to about 100 microns.

31) The method of making a compressible, multilayer article of claim 29, further comprising providing a first electrode having a first major surface and a second major surface and laminating the first major surface of the first electrode to the exposed surface of the first primer layer.

32) The method of making a compressible, multilayer article of claim 30, further comprising providing a first electrode having a first major surface and a second major surface and a second electrode having a first major surface and a second major surface; laminating the first major surface of the first electrode to the exposed surface of the first primer layer; and laminating the first major surface of the second electrode to the exposed surface of the second primer layer.

33) A method of making a compressible, multilayer article comprising:
providing a first electrode having a first major surface and a second major surface;
applying a first primer layer to the first major surface of the first electrode, wherein the thickness of the first primer layer is from about 100 nanometers to about 100 microns;
providing a silicone polymer layer having a first major surface and second major surface; and
laminating the first major surface of the silicon polymer layer to the exposed surface of the first primer layer.

34) The method of making a compressible, multilayer article of claim 33, further comprising providing a second electrode having a first major surface and a second major surface; applying a second primer layer to the first major surface of the second electrode, wherein the thickness of the second primer layer is from about 100 nanometers to about 100 microns; and laminating the second major surface of the silicone polymer layer to the exposed surface of the second primer layer.
